(19) United States
(12) Patent Application Publication
(10) Pub. No.: US 2020/0289349 A1
(43) Pub. Date: Sep. 17, 2020

(54) Litter

(71) Applicant: Jeffrey Dempsey, Spring, TX (US)

(72) Inventor: Jeffrey Dempsey, Spring, TX (US)

(21) Appl. No.: 16/353,725

(22) Filed: Mar. 14, 2019

(51) Int. Cl. A61G 1/013; A61G 1/044

(52) U.S. Cl. CPC A61G 1/013; A61G 1/048; A61G 1/044

(57) ABSTRACT

A litter and a method for using the litter is provided. The litter includes a perimeter strap, one or more horizontal straps, one or more vertical straps, and a canvas forming a second layer, The litter can also include one or more shaping rods for quickly opening the litter.

### BACKGROUND

The present disclosure is directed to a litter for carrying a load.

### DESCRIPTION OF RELATED ART

Certain situations require an injured and/or immobilized individual to be moved from to a secondary location. In some situations, large equipment such as a gurney or a stretcher can be brought to the immobile person, the person loaded thereon, and pushed or wheeled to the secondary location. However, when such tools as a stretcher or gurney are not feasible, more mobile and often lighter weight options are necessary to aid an immobilized person. A need exists for a more versatile option for carrying an immobilized person when a stretcher and/or gurney are not adequate or feasible.

### SUMMARY

One aspect of the disclosed device is to provide a means for carrying one or more persons who are partially or totally immobile. For example, the litter provides carrying means for a soldier injured on the battlefield, a hiker immobilized by an injury, and/or other persons unable to walk. The immobilized person can be positioned on the litter and one or more carriers can take hold of the litter and move it and the immobilized person to another location.

Another aspect of the disclosed device is to provide a litter that is collapsible into a configuration suitable to be stored in a small pouch or pocket.

Another aspect of the disclosed devices is to provide a litter that is self-expanding. That is to say, when the user removes it from its storage pouch and otherwise activated by the user, one or more features of the litter cause the litter to expand into its open configuration. The user can then more quickly attend to the immobilized person and transfer them onto the litter.

Another aspect of the disclosed devices is to provide a litter that has a plurality of handles to provide multiple carrying options.

Additional aspects of the litter can include methods of making and using the same in accordance with the foregoing aspects. It should also be noted that the litter further encompasses the various possible combinations of the aspects and features disclosed herein.

### BRIEF DESCRITION OF THE DRAWING(S)

The accompanying drawings illustrate various exemplary implementations and are part of the specification. The illustrated implementations are proffered for purpose of example, not for purpose of limitation.

FIG. 1 depicts a perspective view of a litter, as shown and described herein.

FIG. 1 a depicts second perspective view of the litter, as shown and described herein.

FIG. 2 depicts a top perspective view of an alternative embodiment of a litter, as shown and described herein.

FIG. 2a depicts a perspective view of a folding litter, as shown and described herein.

FIG. 2b depicts a side view of a folding litter, as shown and described herein.

FIG. 2c depicts a side view of a folding litter, as shown and described herein.

FIG. 2d depicts a side view of a folding litter and container, as shown and described. herein.

FIG. 2e depicts a side view of an unfolding litter and container, as shown and described herein.

FIG. 2f depicts a side view of an unfolding litter, as shown and described herein.

FIG. 2g depicts a perspective view of an unfolding litter, as shown and described herein.

FIG. 3 depicts a perspective top view of the alterative embodiment of a litter with a load, as shown and described herein.

FIG. 4 depicts a perspective top view of another alternative embodiment of a litter, as shown and described herein.

FIG. 5 depicts a perspective top view of another alternative embodiment of a litter, as shown and described herein.

FIG. 6 depicts a perspective top view of another alternative embodiment of a litter, as shown and described herein.

### DETAILED DESCRIPTION

The litter described herein can include one or more perimeter straps forming the exterior boundary for the litter. The boundary can also include one or more head cradles, one or more horizontal straps, and one or more vertical straps. A canvas can be attached to and otherwise disposed within the boundary of the perimeter strap and can form the surface on which a load can be set. In most embodiments, and first and/or second end of each of the horizontal straps and vertical straps can be connected directly to the perimeter strap to provide structural integrity to the litter. The terms “vertical” and “horizontal” are used herein to describe the orientation of the straps in relation to one another, not to describe the orientation of the straps to the ground. For convenience, the terms “horizontal” and “vertical” used to describe the straps are generally intended to correspond to the position of the body/load placed on the litter.

The litter is intended to provide a means for carrying a load. In most cases, that load is intended to be a human or animal body, generally elongated in shape with the weight mostly distributed in a torso region, extending between the body's shoulders and waist. The litter's elongated shape is generally defined by the shape of the canvas and/or the shape of the perimeter strap. For purpose of disclosure, a top section of the litter can be designated as the “head end” and the opposing or bottom section of the litter can be designated as the “foot end” of the litter. The lengths of canvas and/or perimeter strap(s) disposed between the head end and foot end can generally be referred to as the “sides” of the litter; distinguished as a first side, or left side, of the litter and as a second side, or right side, of the litter.

As used herein, the people who might use the litter generally do so in three capacities: the user, the load, and the carrier(s). The “user” refers to the person. who will carry the litter in the collapsed position when it is not in use and will be the person who will retrieve, open, close, and store the litter as it is needed. The “load” refers to the person or other object who is to be placed on the litter and carried from one point to another. As litters are generally used for a means to carry injured or deceased persons, the reader should anticipate that any reference to a “load” being a human body would include a person's head, torso, one or two arms, and one or two legs. The “carrier(s)” refers to one or more persons who are tasked with carrying the litter when it is burdened by the load. As with litters of all kinds, the carrier can most effectively manipulate the position of the litter from one place to another, by each carrier using his/her hand to grasp the litter, lift the litter, and carrier or drag the litter to a secondary location.

As disclosed herein, one or more carrying points can be disposed on the litter for means of effectively carrying the load. For example, one or more handles can be affixed to the perimeter strap so that one or more people can carry the load bearing litter. The litter is also designed to be foldable so that it can be compactly stored when not in use. The litter also can include one or more expanding components so that the litter can be expanded or “opened” with little effort by the user. Quick expansion is particularly beneficial in emergency situations, such as a soldier injured during an ongoing gun fight.

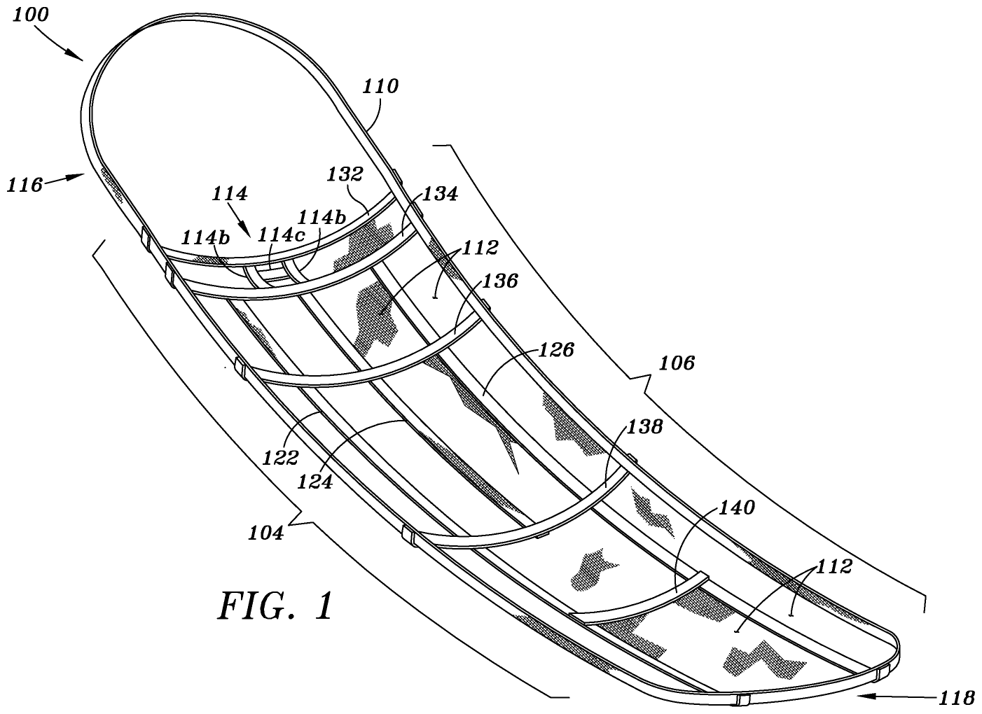

Referring to FIG. 1, the litter 100 can include the perimeter strap 110 forming a frame or boundary for the body of the litter 100. The canvas 112 can be disposed within the perimeter strap 110 to form a semi-solid surface on which a load can be placed. The canvas 112 can be attached to the perimeter strap 110 by sewing, gluing, or other appropriate means so that when a load is placed on the litter 100 and the litter lifted by one or more carriers about the perimeter strap 110, the perimeter strap 110 will remain attached to the canvas 112. The shape of the litter 100, as generally presented by the canvas 112 and perimeter strap 110 assembly, can be generally elongated in shape so as to hold a human body. The head end 116 can be or include a top end of the litter 100 and the foot end 118 can be or include a bottom end of the litter 100.

For additional support for bearing a load, the litter 100 can include the one or more vertical straps (three are shown: 122, 124, 126) and the one or more horizontal straps (four are shown: 132, 134, 136, 138). The litter 100 can include a first horizontal strap, or “cranial strap” 132, a second horizontal strap, or “neck strap” 134, a third horizontal strap, or “torso strap” 136, and a fourth. horizontal strap, or “lower body strap” 138. Each of the horizontal straps 132, 134, 136, 138 generally extend across the litter 100, having a first end attached to the perimeter strap 110 about a first side 104 of the litter and a second end attached to the perimeter strap 110 about a second side 106 of the litter.

The litter 100 can include a head cradle 114 to contain and otherwise support the head of a load. The head cradle 114 can include one or more support straps to provide stability to the head during transit. As shown, the cranial strap 132 and the neck strap 134 can form a portion of the head cradle 114. For example, one or more cradle straps 114a-c can extend or otherwise be disposed between the cranial strap 132 and the neck strap 134 to form the head cradle 114. A first cradle strap 114a can extend between and attach at its ends to the cranial strap 132 and neck strap 134. Similarly, a second cradle strap 114b can extend between and attach at its ends to the cranial strap 132 and neck strap 134. A third cradle strap 114c can extend between the first and second cradle straps 114a, 114b and attach to the first cradle strap 114a about its first end and attach to the second cradle strap 114b about its second end.

The head cradle 114 can take on one or more alternative embodiments (not shown). In a first example, head cradle 114 can include a netted or bungy material for securing the load's head during transit. In a second example, the head cradle 114 can include or more padded materials, such as a pillow of air or a cotton like material.

The vertical straps can be positioned intermittently across the litter 100 and extend from the first and or second horizontal straps 132, 134 to the fourth horizontal strap 138 and/or to the perimeter strap 110 at the foot end of the litter 100. As shown in FIG. 1, the first vertical strap 122 can be connected to the neck strap 134 and extend to the perimeter strap 110 about the foot end 118 of the litter 100. The second vertical strap 1.24 can be connected to the neck strap 134 and extend to the perimeter strap 110 about the foot end 118 of the litter 100. The third vertical strap 126 can be connected to the neck strap 143 and extend to the perimeter strap 110 about the foot end 118 of the litter 100. The vertical straps 122, 124, 126 can be spaced out evenly, or unevenly, to provide support to the litter 100 when a load is carried. As shown, the vertical straps 122, 124, 126 can be evenly, or generally evenly, spread out to provide equal distancing between the perimeter strap 110 at the first side 104 of the litter, the first vertical strap 122, the second vertical strap 124, the third vertical strap 126, and the perimeter strap at the second side 106 of the litter 100.

The litter 100 can also include one or more integrity straps for the purpose of maintaining the integrity of the litter 100. Such integrity straps can be included in portions or regions of the litter 100 that one might expect to endure increased or heightened wear and tear compared to other portions of the litter 100. For example, an integrity strap can be included in the foot end 118 of the litter 100 to account for expected wear and tear from a load's boots during transport. As show, the litter 100 can include a foot strap 140 that extends between the first vertical strap 122 and the third vertical strap 126.

The canvas and the straps disclosed herein can be considered as layers of the litter, with the canvas forming a first layer and the plurality of straps collectively forming the second layer. As shown in FIG. 1a, the canvas 112 can form the top layer and the straps can form the bottom layer. In an alternative embodiment, the canvas can form the bottom layer and the straps can form the top layer. The canvas can be attached to the perimeter strap by sewing, gluing, or other appropriate attachment means. The straps can be attached to one another at any point at which the straps cross or overlay one another. Similar attaching means can be used, including sewing and gluing. In most embodiments, the straps within the perimeter strap will be attached to some other strap at least at its first end and at its second end to provide structural purpose, effectiveness, and strength for that particular strap. The canvas can be attached to the perimeter strap and/or any other strap of the litter. The canvas can be attached to any one or more straps along the entire length of the strap, at one or more attachment points on the strap, or about one or more lengths of the strap.

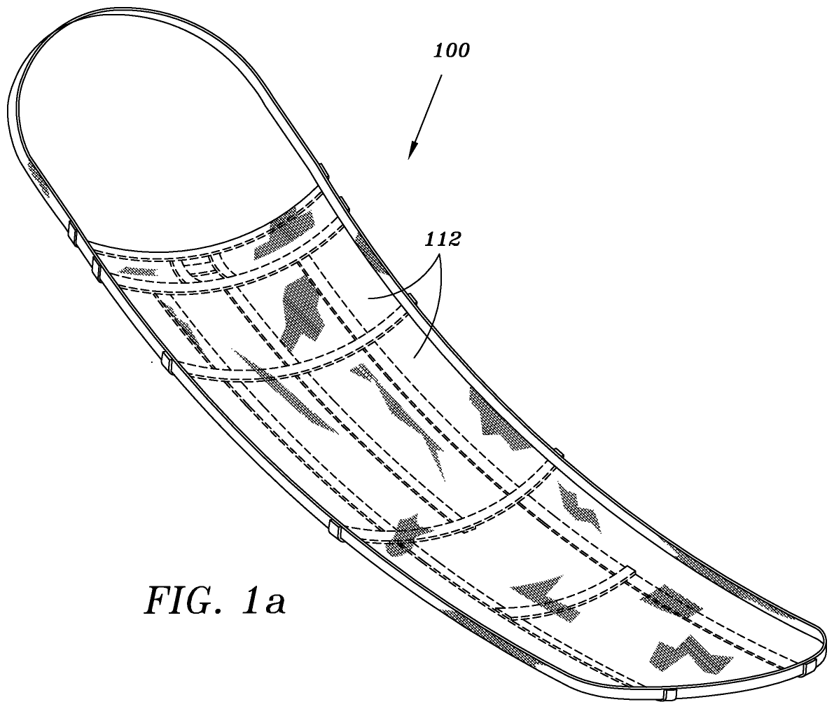

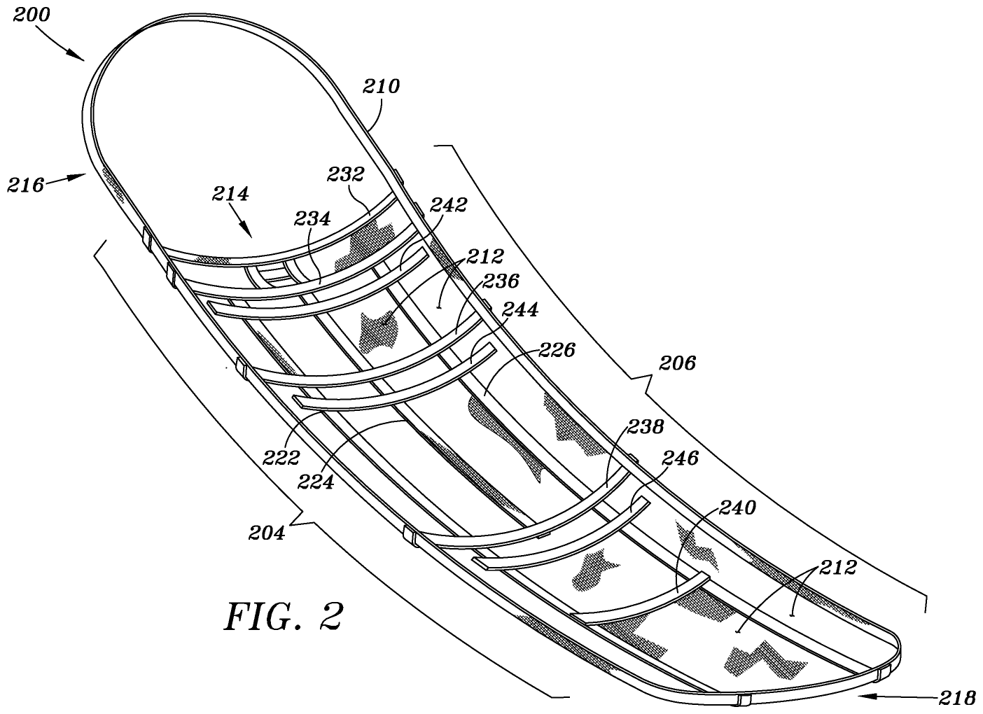

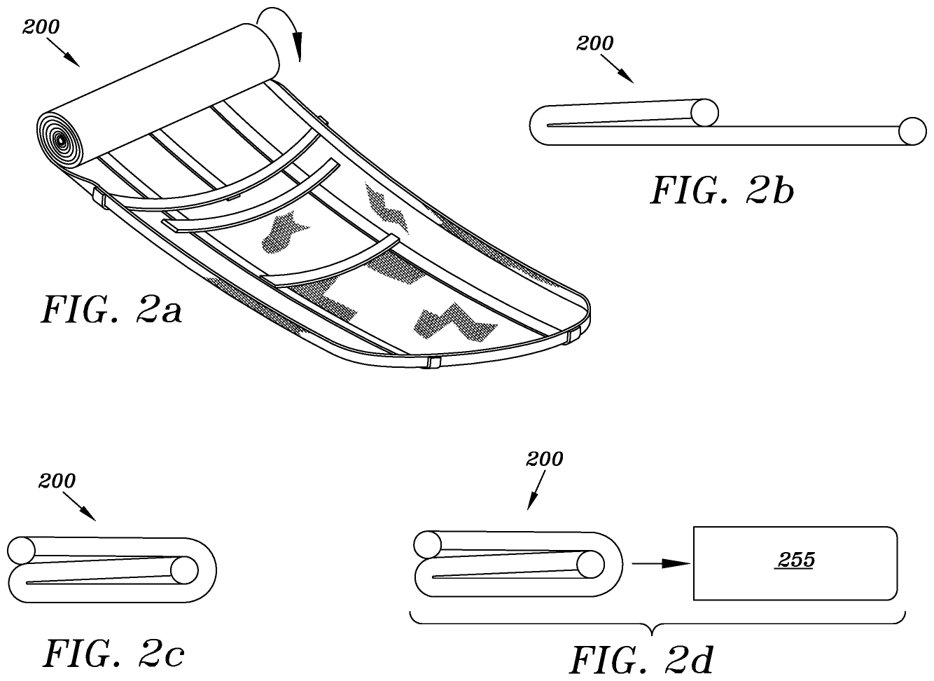

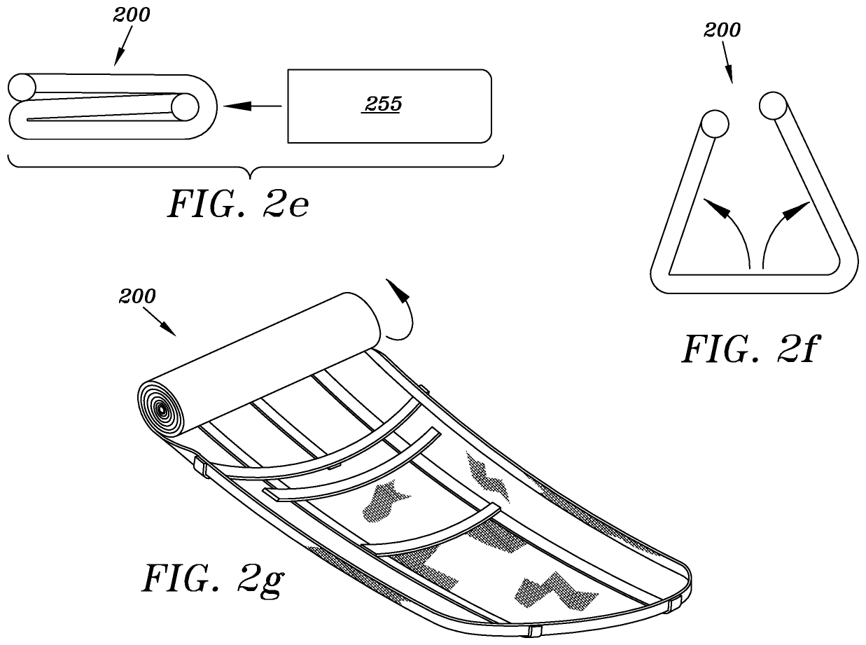

Referring to FIG. 2, a second embodiment of the litter 200 can include one or more horizontal straps 232, 234, 236, 238, one or more vertical straps 222, 224, 226, one or more head cradles 214, one or more integrity straps 240, the canvas 212, one or more shaping rods 242, 244, 246, or any combination thereof. Similar to FIG. 1, the shape and/or orientation of the litter 200 can be defined by perimeter strap 210, a general first side 204 of the litter 200, a general second side 206 of the litter 200, a head end 216, and a foot end 218, The horizontal straps 232, 234, 236 and vertical straps 222, 224, 226 can be distributed across the litter 200 the same as, or similar to, their distribution in FIG. 1.

As discussed below, the litter 200 can be collapsed into one or more configurations for storage. However, when the litter is to be opened, the user is tasked with unfolding or otherwise opening the litter into the open configuration so that it can be used, In an emergency, as with an injured soldier on the battlefield, every second matters when it comes to opening the litter the get it ready for use. The shaping rods are intended to help quicken that process.

The shaping rods can include material that is elastic. For example, the elastic material can include rubber and/or plastic. The shaping rods can also include a fibrous material, such as carbon fiber, being flexible and having shape memory such that it can return to its predetermined shape when not otherwise restrained. The shaping rods can include an apparatus similar to the form and function of tent poles. For example, the shaping rod can include a plurality of tubular metal or plastic sections connected by an elastic or bungy type cord running through the center thereof and connected at the first and second ends of the shaping rod. Upon opening, the bungy cord material can cause tension to draw the plurality of tubular sections together and keep them as such under tension, giving shape to the litter.

In yet another embodiment, the shaping rods can also include or otherwise be made of material that has some shape memory characteristics, Such materials can include shape-memory polymers (SMPs), which are polymeric smart materials that have the ability to return from a deformed state, its temporary shape, to its original (permanent) shape induced by an external stimulus (trigger), such as temperature change.

The shaping rods 242, 244, 246 can be disposed on or otherwise attached to the canvas 212 and/or any one or more of the straps to provide a means for opening the litter 200 into an open position quickly, requiring less burden on the user to take the litter 200 from a closed configuration to an open configuration. The shaping rods can be disposed at one or more positions on the litter 200 and in most cases can be sewn into a housing that is affixed to the canvas 212. For example, the shaping rods can be housed, sewn into, or totally encompassed by a length of canvas or canvas type material. That shaping rod housing can then be separately sewn or other wise attached to the canvas at the desired positions. As described herein in the context of a shaping rod being disposed at a position on the canvas, the shaping rod can be directly attached to the canvas or other parts of the litter or can be housed within a housing that is attached to the canvas or other parts of the litter.

A first shaping rod 242 can be disposed on the canvas 212 below (as shown), above, alongside, and/or in line with the neck strap 234. A second shaping rod 244 can be disposed on the canvas 212 below (as shown), above, alongside, and/or in line with the torso strap 236. A third shaping rod 246 can be disposed on the canvas 212 below (as shown), above, alongside, and/or in line with the lower body strap 238.

The litter 200 can be collapsed and/or compressed into a number of closed configurations for storage. Referring to FIG. 2a, in a first embodiment the litter 200 can be collapsed by rolling the litter 200 about tits vertical length, from the head end 216 to the foot end 218, or vice versa. Referring to FIG. 2b and FIG. 2c, once rolled, the litter can be folded into thirds about its horizontal length. As shown in the figures, the rolled litter 200 can be folded into thirds. In alternative embodiments, the litter 200 can be folded into halves, the litter 200 can be folded into fourths, the litter 200 can be folded into fifths, the litter 200 can be folded into sixths about its horizontal length. Referring to FIG. 2d, once folded the litter 200 can be placed into a storage container 255, The storage container 255 can include a nylon or canvas sack sized to hold the litter in its closed configuration. In one or more embodiments, the storage container 255 can be sewn to the litter 200 such that, once the litter 200 is rolled and folded into its closed configuration, the storage container 255 is still accessible to the user for placing the closed litter into the storage container 255.

The litter 200 can be maneuvered by the user from the closed configuration to the open configuration, The user can remove the litter 200 from the storage container 255 and unfold the litter 200 to the open configuration, If the litter 200 was folded and stored as described in FIG. 2a through FIG. 2d, the user can remove the litter 200 from the storage container 255 as shown in FIG. 2e, unfold the litter 200 about horizontal length as shown in FIG. 2f, and unroll the litter 200 about its vertical length as shown in. FIG. 2g.

The litter can be stored in its closed configuration and is typically stored in its storage container 255. When a litter contains one or more shaping rods, the stored litter is typically under tension as the rods are restrained either by the confines of the storage container or by one or more restraining straps used to keep the litter closed. To maneuver the litter to the open configuration, or at least partially open configuration (for example, as shown in FIG. 2f), the user can remove the restraint placed on the litter. To do this the user can carefully grasp the litter within the storage container so that his hand now acts to keep the litter closed, remove the litter from the storage container, arid release his grip on the litter. The litter is then free to open as much is provided by the shaping rods disposed on that embodiment of the litter. Once the shaping rods have exhausted their effect, the user can then finish the opening process by hand (such as unrolling the litter as shown in FIG. 2g).

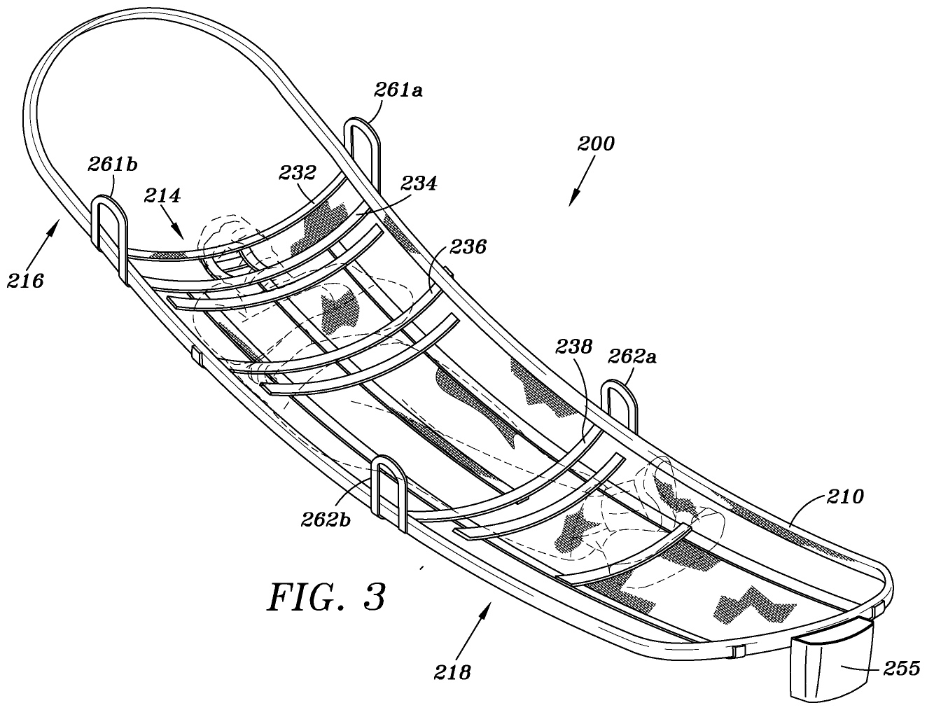

Once in the open configuration, the load can be laid on the litter 200 as shown in FIG. 3. In most cases, the load will be a human or animal body, generally elongated in shape with the weight mostly distributed in a torso region, extending between the body's shoulders and waist, The person's head can be placed on or about the head cradle at the head end 216 with the body extending downward so that the feet are disposed on or about the foot end 218, The person's chest and torso can be placed on or about the litter over a region of the litter that includes the torso strap 236. The person's legs can be placed on or about the litter over a region of the litter that includes the lower body strap 238.

Once the load is in position, the carrier(s) can take hold of the litter, lift, and move the litter to another location. As also shown in FIG. 3, the litter 200 can include a plurality of handles for carrying of the litter 200. For example, the litter 200 can have one or more side handles, which can include a forward left-side handle 261a, a forward right-side handle 261b, a rear-left side handle 262a, and a rear right-side handle 262b. The side handles can be distributed about the right and left sides of the litter 200 to provide adequate weight distribution of the load on the carriers so that each carrier is burdened with approximately the same weight as the other carriers. The handles are also distributed around sides of the litter in such a way as to ensure the load stays in the litter, and does not topple over, with the load is being carried. In an alternative embodiment, though not show, the litter can have two or more side handles, six or more side handles, eight or more side handles, or ten or more side handles. Though not shown, the litter can also have one or more handles disposed about the bottom end of the litter.

In one or more embodiments, the litter 200 can be carried or dragged by a single person taking hold of a top section of the perimeter strap 210. Specifically, the top section of the perimeter strap can include the length of the perimeter strap 210 the extends above and loops around the ends of the cranial strap 232. The canvas can be left out or otherwise absent from the section of the litter encompassed by this top portion of the perimeter strap 210. As such, the carrier can place his body within this loop, place the top portion of the perimeter strap 210 around his body (over his shoulder and/or around his chest) and draft the litter 100 burdened by the load. With this method, a single user can at least drag the litter 100 with the load to a second location.

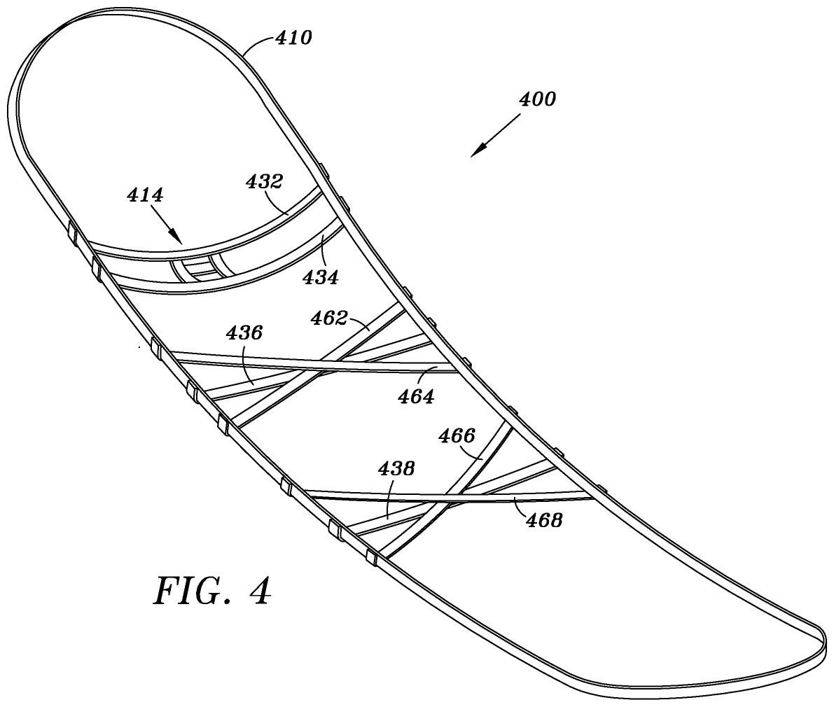

Referring to FIG. 4, an alternative embodiment of the litter 400 can include a perimeter strap 410, a cranial strap 432, a neck strap 434, a head cradle 414, a torso strap 436, a lower body strap 438, and one or more cross-section straps 462, 464, 466, 468. As shown, the canvas can be absent, though, in other embodiments, the canvas can be included on one or more portions of the litter. The one or more cross section straps can include two torso cross section straps 462, 464 that each attach to the perimeter strap at each end and crisscross as they cross each other (and/or the torso strap 436) about the middle of the litter 400. The one or more cross section straps can also include two lower body cross section straps 466, 468 that each attach to the perimeter strap at each end and crisscross as they cross each other (and/or the lower body strap 438) about the middle of the litter 400.

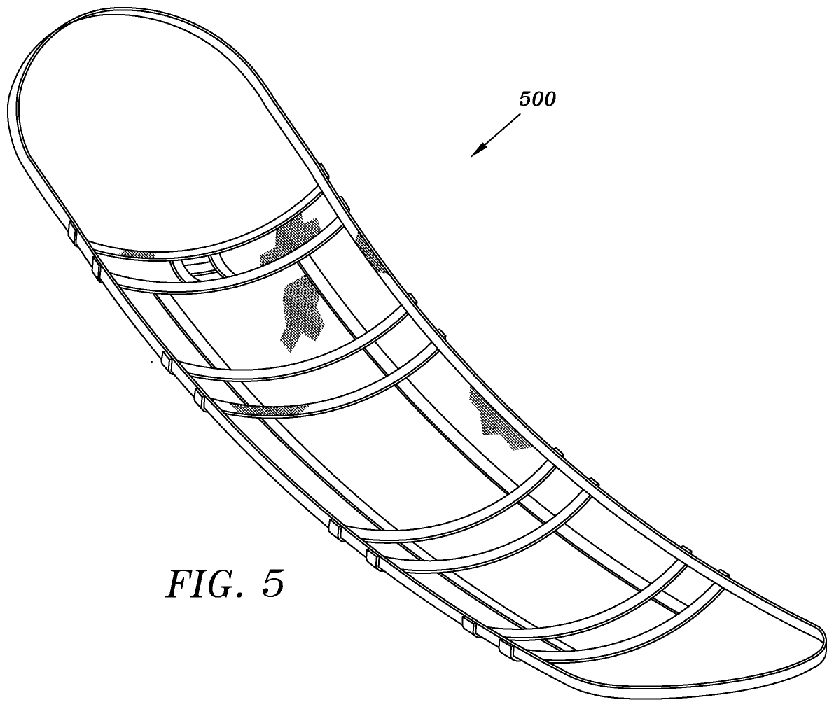

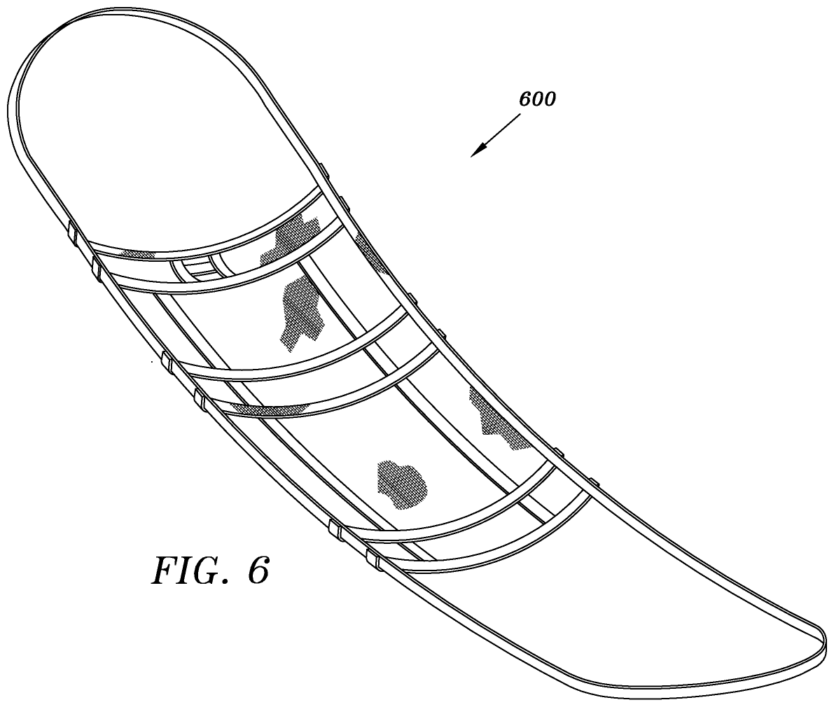

FIG. 5 depicts an alternative embodiment of the litter 500 having perimeter strap, a cranial strap, a neck strap, a head cradle, two parallel torso straps, two mid-body or lower body straps, two foot straps, and two vertical straps that extend between the neck strap and the two foot straps.

FIG. 6 depicts an alternative embodiment of the litter 600 having perimeter strap, a cranial strap, a neck strap, a head cradle, two parallel torso straps, two mid-body or lower body straps, and two vertical straps that extend between the neck strap and the two foot straps, The portion of the canvas below the lower of the two foot straps can be open, otherwise not containing the canvas, so that a carrier can use the large looped portion of the perimeter strap at the bottom of the litter as a drag strap.

In one or more embodiments, the canvas can be included for a portion or all the litter within the perimeter strap, In some embodiments, I may be preferable to have the canvas absent from one or more portions of the litter to provide for easier carrying, lighter overall weight, and/or personal preference.

The distance between each strap is not dependent upon an exact quantifiable distance, rather a relative distance between all components/straps of the litter such that the weight distribution of a load is accounted for to provide easier means of carrying for the one or more persons carrying the load on the litter, Similarly, the distance between straps will depend on the size of the litter and the expected load to be carried in general use. For example, litters manufactured for the expected use of carrying very heavy load might include several more vertical straps and/or several more horizontal straps. Similarly, litters manufactured for the expected use of carrying light loads might include fewer horizontal straps and/or fewer vertical straps. The number of straps of the litter will often also take into existence its storability and weight of the overall litter. For example, a litter intended to be carried by a medical soldier in the filed of battle needs to be as light as possible, while still as durable and dependable as possible, so the soldier can still perform his tasks while carrying the stored litter on his person. In that regard, the material used to manufacture the litter and/or the amount of material used to manufacture the litter can be modified for optimization.

Although the present litter has been described with respect to specific details and embodiments, it is not intended that such description be regarded as limitations on the scope of the apparatus. It will thus be appreciated that those skilled in the art will be able to devise numerous alternative arrangements that, while not shown or described herein, embody the principles of the disclosure and thus are within its spirit and scope.

What is claimed is:

1. A litter comprising:
a perimeter strap;
one or more horizontal straps and one or more vertical straps forming a first layer; and
a canvas forming a second layer.

2. The litter of claim 1, further comprising a head cradle disposed between a first vertical strap and a second vertical strap.

3. The litter of claim 1, wherein the one or more horizontal straps are distributed across the litter such that a first end of each horizontal strap is connected to a first side of the litter and a second end of each horizontal strap is connected to a second side of the litter.

4. The litter of claim 3, wherein the one or more vertical straps are distributed across the litter such that a first end of each vertical strap is connected to a first horizontal strap and a second end of each vertical strap is connected to the perimeter strap about a foot end of the litter.

5. The litter of claim 1, wherein the one or more horizontal straps are intermittently spaced across the litter from a first side of the litter to a second side of the litter, wherein the one or more vertical straps are intermittently spaced across the litter from a head end of the litter to a foot end of the litter, and wherein the horizontal straps are connected to the vertical straps at the points the straps overlap.

6. A litter comprising:
a perimeter strap forming a first side of the litter, a second side of the litter, a head end of the litter, and a foot end of the litter;
one or more horizontal straps;
one or more verticals straps; and
a canvas attached to at least one of the perimeter strap, the one or more horizontal straps, or the one or more vertical straps.

7. The litter of claim 6, wherein the one or more horizontal straps comprise a cranial strap, a neck strap, a torso strap, and a lower body strap.

8. The litter of claim 7, wherein the one or more vertical straps comprise a first vertical strap, a second vertical strap, and a third vertical strap and wherein each of the vertical straps is connected to the neck strap about a first end.

9. A litter comprising:
a perimeter strap;
one or more horizontal straps and one or more vertical straps collectively forming a first layer;
a canvas forming a second layer; and
one or more shaping rods disposed on the litter, wherein the shaping rods provide tension to hold the litter in an open position.
